(19) United States
(12) Patent Application Publication
(10) Pub. No.: US 2015/0022448 A1
(43) Pub. Date: Jan. 22, 2015

(54) CURSOR CONTROLLING DEVICE

(71) Applicant: DEXIN CORPORATION, NEW TAIPEI CITY (TW)

(72) Inventor: YUAN-JUNG CHANG, NEW TAIPEI CITY (TW)

(21) Appl. No.: 13/947,432

(22) Filed: Jul. 22, 2013

(51) Int. Cl. G06F 3/0354

(52) U.S. Cl. CPC G06F 3/03543
USPC 345/163

(57) ABSTRACT

A cursor controlling device for transmitting a cursor controlling signal to a computer to control a cursor displayed on the screen of the computer. The cursor controlling device comprises a main body, a displacement detecting unit, a pressing switch and a controlling unit. The displacement detecting unit disposed on the surface of the main body generates the cursor controlling signal. The pressing switch disposed on the surface of the main body generates a pressing signal. The controlling unit disposed in the main body is electrically coupled to the displacement detecting unit and the pressing switch. The controlling unit comprising a firmware receives the cursor controlling signal and the pressing signal and transmits the cursor controlling signal to the computer. When the controlling unit receives the pressing signal, the controlling unit lowers the resolution of the cursor controlling signal and transmits a function signal to the computer.

### BACKGROUND OF THE INVENTION

1. Field of the Invention

The instant disclosure relates to an input device; in particular, to a cursor controlling device related to an input device.

2. Description of Related Art

An adequate input device is needed for using the computer program (or software). For example, the user has to manipulate a cursor controlling device to (such as a computer mouse) to control the cursor shown on the screen. Generally, the cursor controlling device utilizes a displacement detecting unit to convert the displacement made by the manipulation of the user in a space (generally referred to a plane) to a displacement of the cursor. The displacement detecting unit may be an optical sensor, a trackball, or a touch pad. According to the operation principle of the displacement detecting unit, the resolution (or so called “sensitivity”) is represent by DPI (Dots Per Linear Inch). When the value of the DPI is greater, the resolution of the cursor controlling device is higher and the moving speed of the cursor goes faster. For example, when the displacement detecting unit is an optical sensor, the cursor on the screen could move more distance under the same movement distance (made by the user) of the computer mouse. When the value of the DPI is smaller, the user needs to move the computer mouse with more distance for the same movement of the cursor. Furthermore, the functional commands of the software vary due to the software design, and each command is entered by the user with an input device. Meanwhile, the user may need to control the cursor shown on the screen.

### SUMMARY OF THE INVENTION

The object of the instant disclosure is to provide a cursor controlling device. When the pressing switch is pressed, the displacement resolution of the cursor controlling signal is lowered and a function signal is transmitted to the computer.

In order to achieve the aforementioned objects, according to an embodiment of the instant disclosure, a cursor controlling device is offered. The cursor controlling device is for transmitting a cursor controlling signal to a computer to control a cursor displayed on the screen of the computer. The cursor controlling device comprises a main body, a displacement detecting unit, a pressing switch and a controlling unit. The displacement detecting unit is disposed on the surface of the main body and generates the cursor controlling signal. The pressing switch is disposed on the main body and generates a pressing signal when the pressing switch is pressed. The controlling unit is disposed in the main body and is electrically coupled to the displacement detecting unit and the pressing switch. The controlling unit comprises a firmware. The controlling unit receives the cursor controlling signal and the pressing signal and transmits the cursor controlling signal to the computer. When the controlling unit receives the pressing signal, the controlling unit lowers the displacement resolution of the cursor controlling signal and transmits a function signal to the computer.

In summary, the cursor controlling device utilizes a signal pressing switch (i.e. a button or a key) to execute the functions of lowering the displacement resolution for the cursor and popping out the built in function icon (or image) of the software. The function icon (or image) may be an aiming front sight, or may be an enlarged image representing the enlarged local image around the cursor for providing the magnifier function in the graphics software or the image processing software, such that the user may manipulate the cursor controlling device more easily.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a circuit block diagram of a cursor controlling device according to an embodiment of the instant disclosure;

FIG. 2A shows a schematic diagram of a cursor controlling device controlling a cursor displayed on the screen of a computer according to an embodiment of the instant disclosure;

FIG. 2B shows a schematic diagram of a cursor controlling device controlling a cursor displayed on the screen of a computer according to an embodiment of the instant disclosure;

FIG. 3A shows a schematic diagram of a cursor controlling device controlling a cursor displayed on the screen of a computer according to another embodiment of the instant disclosure; and

FIG. 3B shows a schematic diagram of a cursor controlling device controlling a cursor displayed on the screen of a computer according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### [An Embodiment of the Cursor Controlling Device]

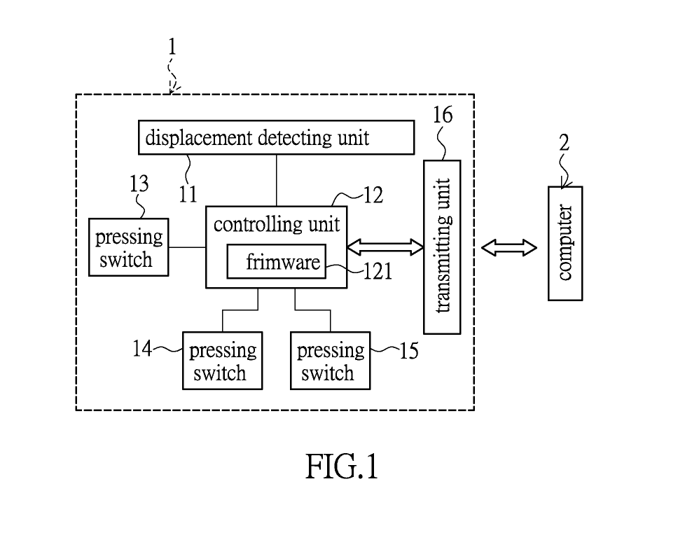

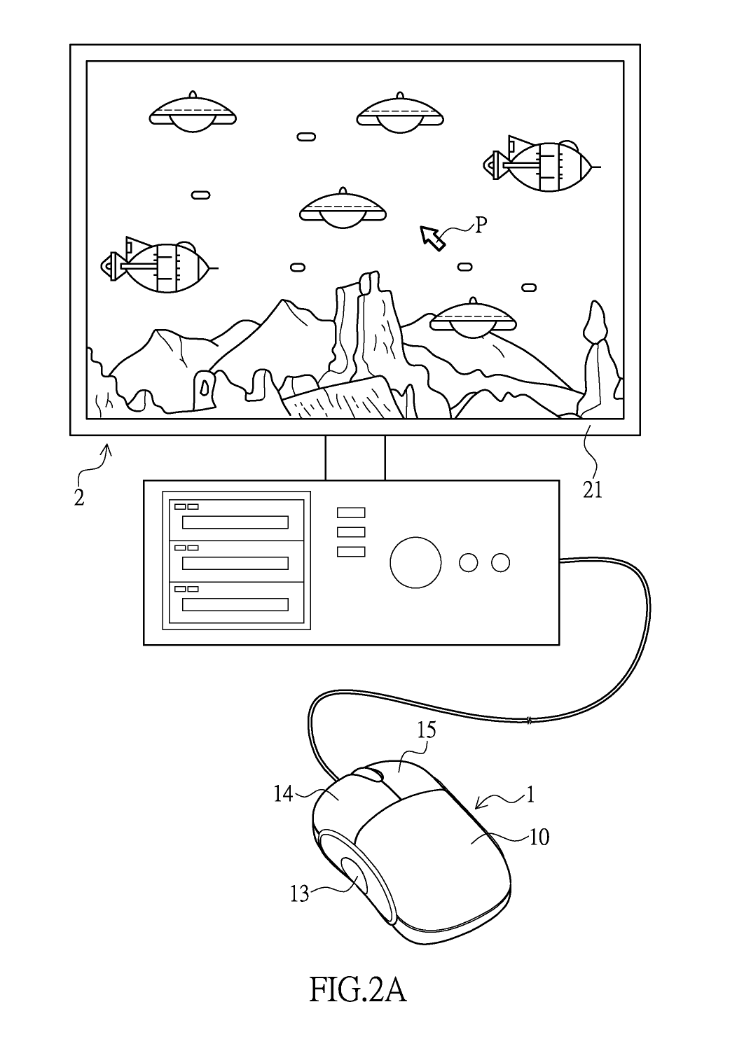

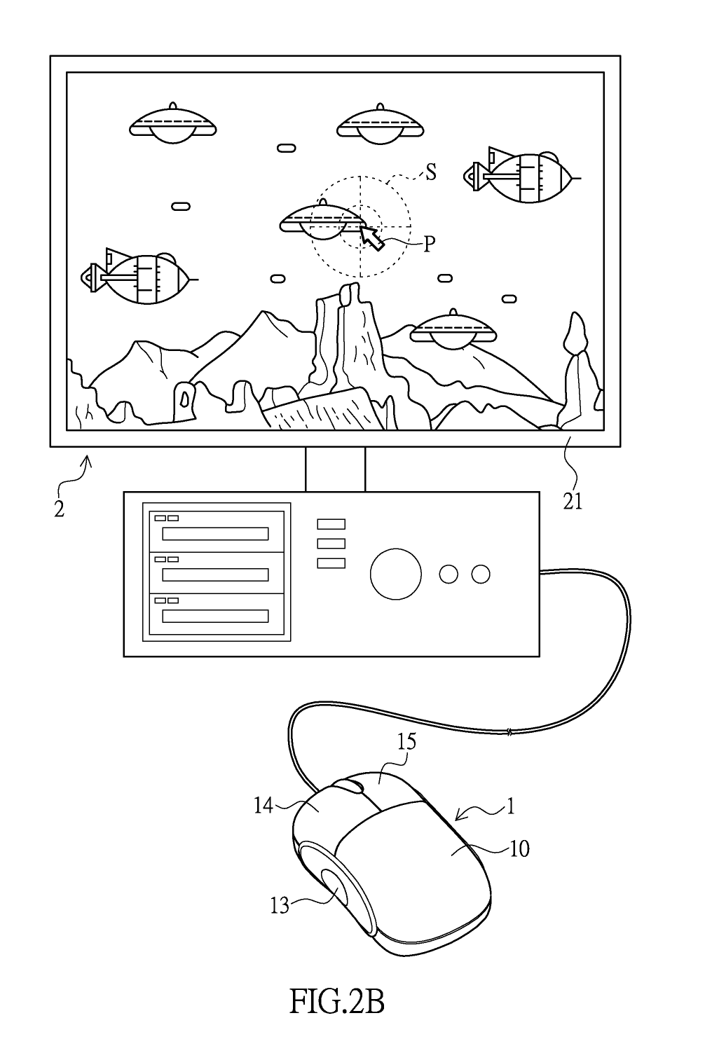

Please refer to FIG. 1 and FIG. 2A. FIG. 1 shows a circuit block diagram of a cursor controlling device according to an embodiment of the instant disclosure. FIG. 2A shows a schematic diagram of a cursor controlling device controlling a cursor displayed on the screen of a computer according to an embodiment of the instant disclosure. A cursor controlling device 1 may be a computer mouse. The cursor controlling device 1 is for transmitting a cursor controlling signal to a computer 2 to control a cursor P displayed on the screen 21 of the computer 2. The cursor controlling device 1 comprises a main body 10 (shown in FIG. 2A), a displacement detecting unit 11, pressing switches 13, 14 and 15, a controlling unit 12 and a transmitting unit 16. The main body 10 may be the casing of the cursor controlling device 1 for accommodating the required circuits. The cursor controlling device 1 is one kind of the input device. Therefore, the cursor controlling device 1 has at least a pressing switch. In this embodiment, three pressing switches 13, 14 and 15 are disclosed, but the present invention is not so restricted. And the appearance of the main body 10 is not restricted thereto.

The displacement detecting unit 11 is disposed on the surface of the main body 10. In this embodiment, the displacement detecting unit 11 is disposed on the bottom surface of the main body 10 (not shown in FIG. 2A). The pressing switches 13, 14 and 15 are disposed on the surface of the main body 10 (shown in FIG. 2A). The controlling unit 12 is disposed in the main body 10 and is electrically coupled to the displacement detecting unit 11 and the pressing switches 13, 14 and 15. The controlling unit 12 is connected to the computer 2 through the transmitting unit 16. The transmitting unit 16 may be a wired transmitting unit or a wireless transmitting unit. In this embodiment, the transmitting unit 16 is a wired transmitting unit, such as a PS/2 interference or a Universal Serial Bus (USB).

The displacement detecting unit 11 may be an optical sensor, a trackball or a touch pad, but the present invention is not so restricted. The displacement detecting unit 11 generates the cursor controlling signal. When the displacement detecting unit 11 is an optical sensor, the displacement detecting unit 11 disposed on the bottom surface of the main body 10 could detect the displacement of the cursor controlling device 1 on a plane and convert the detected displacement to the cursor controlling signal. The displacement detecting unit 11 generates the cursor controlling signal with a preset first displacement resolution. Additionally, the displacement resolution could be stored in the register of the controlling unit 12.

The pressing switches 13, 14 or 15 may be the left press-button, the middle press-button and the right press-button of the computer mouse, or may be any button designed on the computer mouse. The pressing switch 13 (14 or 15) generates a pressing signal when the pressing switch 13 (14 or 15) is pressed. In other words, the pressing switch 13 (14 or 15) generates the pressing signal according to the physical pressing of the user. As shown in FIG. 2A, the pressing switch 14 and pressing switch 15 are the left press-button and the right press-button of the computer mouse performing typical mouse functions.

The controlling unit 12 comprises a firmware 121. The firmware 121 of the controlling unit 12 could configure the displacement resolution of the cursor controlling signal. According to the displacement signal of the displacement detecting unit 11, the firmware could generate the cursor controlling signal corresponding to at least two kinds of resolutions. The displacement resolution of the cursor controlling signal providing from the cursor controlling device 1 to the computer 2 is adjusted by the cursor controlling device 1 itself. The user does not need to install any specific driver or software for the cursor controlling device 1 to the computer 2, in order to adjust the displacement resolution of the cursor controlling signal.

The controlling unit 12 receives the cursor controlling signal form the displacement detecting unit 11 and the pressing signals from the pressing switches 13, 14 and 15. The controlling unit 12 transmits the cursor controlling signal to the computer 2 through the transmitting unit 16. When the controlling unit 12 receives the pressing signal generated by the pressing switch 13, the controlling unit 12 lowers the displacement resolution of the cursor controlling signal and transmits a function signal to the computer 2.

More specifically, when the pressing switch 13 is not pressed, the controlling unit 12 transmits the cursor controlling signal with a first displacement resolution to the computer 2. When the pressing switch 13 is pressed, the controlling unit 12 transmits the cursor controlling signal with a second displacement resolution to the computer 2. The second displacement resolution is lower than the first displacement resolution. Furthermore, when the pressing switch 13 is released after being pressed, the controlling unit 12 reverts to transmit the cursor controlling signal with the first displacement resolution to the computer 2. However, the manner of changing resolution of the cursor controlling signal of the present does not so restricted when the pressing switch 13 is released after being pressed. As long as the controlling unit 12 receives the pressing signal generated by the pressing switch 13, the controlling unit 12 lowers the resolution of the cursor controlling signal and transmits a function signal to the computer 2. Please refer to following segments for detailed application manner of the cursor controlling device 1.

It is worth mentioning that the function signal refer to a control command varies due to application programs. The controlling unit 12 may also comprise a memorizing unit (not shown in the figure) for storing at least one set of the host controlling signal. The computer controlling signal corresponding to the control command varies due to the applications.

Please refer to FIG. 2A again. The function signal is corresponding to a related function when the user controls the cursor P. As shown in FIG. 2A, when the user does not press the pressing switch 13 the user controls the cursor P as usual. Meanwhile, the displacement detecting unit 11 generates the cursor controlling signal with a preset first displacement resolution. The user controls the cursor P to move up, move down, move left or move right on the screen 21.

Please refer to FIG. 2B showing a schematic diagram of a cursor controlling device controlling a cursor displayed on the screen of a computer according to an embodiment of the instant disclosure. When the user is playing a shooting game, the position of the cursor P on the screen may be located at the target which is should be knock down, such as an enemy or an object. When the user plays the game, the user may need an aiming front sight icon to control the cursor P to aim at the target in a fast way. Then, the user could press any other pressing switch (or key) of the cursor controlling device 1 for shooting. The user could use the interface of the button configuration of the game to configure the pressing switch 13 corresponding to a command for opening the aiming front sight icon.

In order to aim at the target fast, the pressing switch 13 of the embodiment provides the functions of lowering the resolution of the cursor controlling signal and popping out the aiming front sight icon. In other words, when the user presses the pressing switch 13 the controlling unit 12 receives the pressing signal generated by the pressing switch 13. Then, the controlling unit 12 lowers the displacement resolution of the cursor controlling signal and transmits the function signal to the computer 2. The function signal makes the computer generates an aiming front sight icon S on the screen 21. The aiming front sight icon S is corresponding to the cursor P shown on the screen 21. Generally, the center (or the circle center) of the aiming front sight icon S is the cursor P. When the user keeps pressing the pressing switch 13, the aiming front sight icon S helps the user to aim at the target. Meanwhile, the resolution of the cursor controlling signal is lowered, thus the user may substantially move the cursor controlling device 1 (when the cursor controlling device 1 is a computer mouse) to alter the position of the cursor P in the assistance of the aiming front sight icon S. Therefore, the user may be easier to make a precise targeting. When the user moves the cursor controlling device 1 a little (for example, the user made a slip moving due to emotional stress), the aiming front sight icon S would not be deviate from the target substantially, especially for the condition that the target is moving or the target is quite small.

### [Another Embodiment of the Cursor Controlling Device]

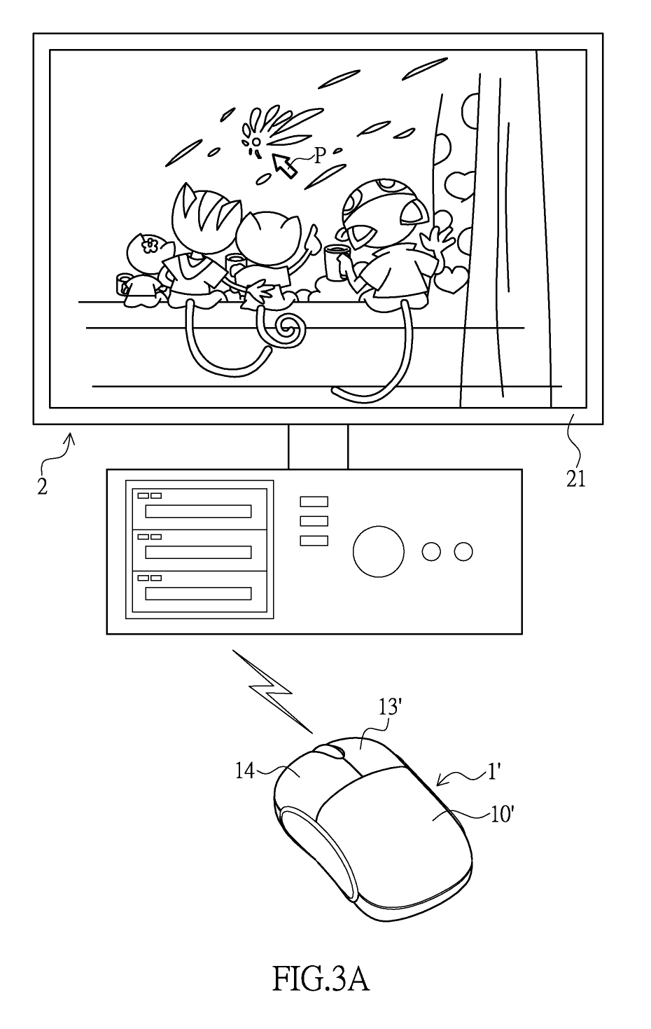

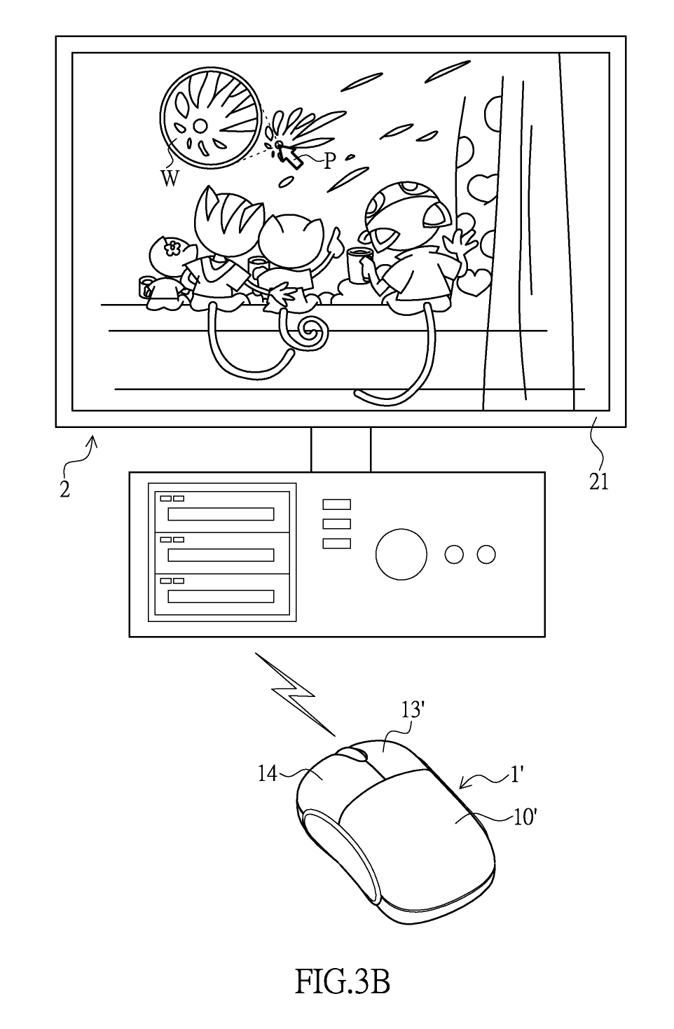

Please refer to FIG. 1, FIG. 2A and FIG. 3A. FIG. 3A shows a schematic diagram of a cursor controlling device controlling a cursor displayed on the screen of a computer according to another embodiment of the instant disclosure. The cursor controlling device 1′ is significantly identical to the cursor controlling device 1 of the previous embodiment except for differences specified in the follows. The positions and the numbers of the pressing switches are different, and the cursor controlling device 1′ has a wireless transmitting unit. The wireless transmitting unit (corresponding to the transmitting unit 16) is coupled to the controlling unit 12, and the controlling unit 12 transmits the cursor controlling signal and the function signal to the computer 2 through the wireless transmitting unit. As shown in FIG. 3A, the pressing switch 13′ of the cursor controlling device 1′ is corresponding to the pressing switch 13 shown in FIG. 2A, and the pressing switch 14 is the general left button of the mouse. The main body 10′ may different from the main body 10 shown in FIG. 2A. In order to describe the instant disclosure in an understandable and clear way, the cursor controlling device 1′ in this embodiment is used for controlling the operation of the graphics software or the image processing software. However, this shouldn't be the limitation to the present invention.

Please refer to FIG. 3B showing a schematic diagram of a cursor controlling device controlling a cursor displayed on the screen of a computer according to another embodiment of the instant disclosure. When the user use the graphics software or the image processing software, the function of magnifier for zoom in is widely utilized for dealing with detail graphic (or image). The user may configure the pressing switch 13′ to be a hotkey of executing the function of magnifier in the graphics software or the image processing software. When the user moves the cursor near to the graphic (or image) needed for dealing with in detail, the user may press the pressing switch 13′. Then, the function signal makes the computer 2 to generate an enlarged image W. The enlarged image W represents the enlarged local image around the cursor P displayed on the screen 21. More specifically, the user presses the pressing switch 13′ to execute the function of magnifier; meanwhile, the displacement resolution of the cursor controlling signal is lowered. Therefore, the user may substantially manipulate the cursor controlling device 1′, such that the displacement detecting unit 11 could detect a substantially displacement. Because the enlarged image W represents the enlarged local image around the cursor P displayed on the screen 21, the cursor controlling with a lower resolution is well adapted for detail adjustment of the enlarged local image, such as drawing lines or selecting image elements (or pixels).

According to above descriptions, the cursor controlling device utilizes a signal pressing switch (i.e. a button or a key) to execute the functions of lowering the displacement resolution for the cursor and popping out the built in function icon (or image) of the software. The function icon (or image) may be an aiming front sight for fast aiming when the user is playing a game, in order to providing visual effects and action feeling. The function icon (or image) may also be an enlarged image represents the enlarged local image around the cursor for providing the magnifier function in the graphics software or the image processing software.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A cursor controlling device for transmitting a cursor controlling signal to a computer to control a cursor displayed on the screen of the computer, the cursor controlling device comprising:
a main body;
a displacement detecting unit, disposed on the surface of the main body, generating the cursor controlling signal;
a pressing switch, disposed on the main body, generating a pressing signal when the pressing switch is pressed; and
a controlling unit, disposed in the main body, electrically coupled to the displacement detecting unit and the pressing switch, and comprising a firmware, wherein the controlling unit receives the cursor controlling signal and the pressing signal and transmits the cursor controlling signal to the computer, wherein when the controlling unit receives the pressing signal, the controlling unit lowers the displacement resolution of the cursor controlling signal and transmits a function signal to the computer.

2. The cursor controlling device according to claim 1, wherein the controlling unit further comprises a memorizing unit, the memorizing unit stores at least one set of the host controlling signal.

3. The cursor controlling device according to claim 1, wherein the function signal makes the computer generate an aiming front sight icon displayed on the screen, the aiming front sight icon is corresponding to the cursor displayed on the screen.

4. The cursor controlling device according to claim 1, wherein the function signal makes the computer generate an enlarged image, the enlarged image represents the enlarged local image around the cursor displayed on the screen.

5. The cursor controlling device according to claim 1, wherein the controlling unit transmits the cursor controlling signal with a first displacement resolution to the computer when the pressing switch is not pressed, the controlling unit transmits the cursor controlling signal with a second displacement resolution to the computer when the pressing switch is pressed, the second displacement resolution is lower than the first displacement resolution.

6. The cursor controlling device according to claim 5, wherein the controlling unit reverts to transmit the cursor controlling signal with the first displacement resolution to the computer when the pressing switch is released after being pressed.

7. The cursor controlling device according to claim 1, wherein the cursor controlling device is a computer mouse.

8. The cursor controlling device according to claim 7, wherein the pressing switch is a left press-button, a middle press-button or a right press-button of the computer mouse.

9. The cursor controlling device according to claim 1, wherein the displacement detecting unit is an optical sensor, a trackball or a touch pad.

10. The cursor controlling device according to claim 1, wherein the displacement resolution of the cursor controlling signal is stored in a register of the controlling unit.

11. The cursor controlling device according to claim 1, further comprising:
a wireless transmitting unit, electrically coupled to the controlling unit, wherein the controlling unit transmits the cursor controlling signal and the function signal to the computer through the wireless transmitting unit.
